(19) United States
(12) Patent Application Publication
(10) Pub. No.: US 2026/0121846 A1
(43) Pub. Date: Apr. 30, 2026

(54) SYSTEM AND METHOD FOR TOKENIZATION OF SENSITIVE DATA ACROSS COMPUTING ENVIRONMENTS

(71) Applicant: DIGITRANS LLC, Elkhorn, NE (US)

(72) Inventor: Ghislain Agbekponou, Elkhorn, NE (US)

(21) Appl. No.: 19/371,594

(22) Filed: Oct. 28, 2025

Related U.S. Application Data
(60) Provisional application No. 63/713,168, filed on Oct. 29, 2024.

(51) Int. Cl. H04L 9/08; H04L 9/40

(52) U.S. Cl. CPC H04L 9/0877; H04L 63/0428; H04L 63/105; H04L 63/1416; H04L 63/20

(57) ABSTRACT

A system for protecting sensitive data through vaulted and vaultless tokenization across a distributed computing environment is provided. The system includes a processor and memory containing multiple integrated modules to secure data transmission and storage. A tokenization application programming interface (API) receives sensitive data from the distributed computing environment through a network. An encryption module applies format-preserving cryptographic transformation to the sensitive data, creating encrypted data while preserving original data format and length characteristics. A tokenization engine receives the encrypted data and generates format-preserving tokens that include structural characteristics based on the sensitive data. A management module processes encrypted data and format-preserving tokens to generate cryptographic responses. An enforcement module applies authorization rules for access control based on user roles and data classification levels. The tokenization API provides the format-preserving tokens and the cryptographic responses back to the distributed computing environments according to established user roles and data classification.

### CROSS-REFERENCE TO RELATED APPLICATIONS

This application claims the benefit of U.S. Provisional Application No. 63/713,168, filed on Oct. 29, 2024. The entire disclosure of the above application is incorporated herein by reference.

### FIELD

The present technology relates to systems and methods for data protection and tokenization systems for securing sensitive information in digital environments and, more particularly, to cryptographic tokenization for security service architectures for healthcare data management applications.

### INTRODUCTION

This section provides background information related to the present disclosure which is not necessarily prior art.

Healthcare organizations today face multiple challenges in protecting sensitive data while maintaining operational efficiency and regulatory compliance. Healthcare data breaches occur more often, with unauthorized access to Personal Health Information (PHI) and Personally Identifiable Information (PII), potentially exposing patients to identity theft and undermining trust in the healthcare industry. Cyberattacks, including ransomware and phishing, may target healthcare organizations specifically because medical records possess high value on illicit markets. Internal threats from both malicious and negligent employees may contribute to data exposure through improper handling of sensitive information. These security incidents may cause financial damage while potentially violating patient privacy rights under federal and state regulations.

Certain tokenization methods employed to protect sensitive data, for example, methods of replacing sensitive data with a nonsensitive and unique token in applications and databases, may rely on centralized vault architectures, e.g., storing the original sensitive data in a separate secure database and utilizing the token for transactions and data sharing instead, that create performance bottlenecks and scalability limitations. These vault-based approaches may require extensive database lookups for token mapping, which can introduce latency issues in high-traffic environments. The centralized nature of these systems may create single points of failure that could compromise tokenization infrastructures. Additionally, certain vault-based systems may require complex maintenance and administrative overhead to manage token mapping and allow for data integrity across distributed environments. In other words, such architectures may limit the ability of organizations to efficiently scale their data protection capabilities.

Regulatory compliance requirements may present increasingly complex challenges for healthcare organizations managing sensitive data. For example, the Centers for Medicare & Medicaid Services (CMS) may push for comprehensive value-based care programs in the future, which could require enhanced data sharing and analytics capabilities while maintaining strict privacy protections. Compliance with regulations such as the Health Insurance Portability and Accountability Act (HIPAA), the General Data Protection Regulation (GDPR), and the Health Information Technology for Economic and Clinical Health (HITECH) may demand robust protection of patient data throughout its lifecycle. Organizations may struggle to implement data minimization principles while maintaining the functionality required for healthcare operations and research. Certain compliance frameworks may therefore require immutable audit trails and detailed logging of data access events, which other systems may not adequately support.

Interoperability between healthcare systems may likewise be hampered by security concerns and incompatible data protection mechanisms. Healthcare providers, insurers, laboratories, and specialty systems may operate with disparate data formats and security protocols that impede seamless information exchange. Electronic Health Records (EHRs) and Personal Health Records (PHRs) may utilize different tokenization approaches that prevent effective data integration across platforms. Legacy systems may lack the capability to process protected data in formats that maintain compatibility with newer security requirements. These interoperability challenges may prevent healthcare organizations from achieving the coordinated care goals that value-based care programs may demand.

Data analytics and research capabilities may also be severely constrained by data protection approaches that limit access to meaningful datasets. For example, healthcare organizations may need to perform population health studies, clinical research, and operational analytics using patient data while maintaining privacy protections. Protection methods may render data unusable for analytical purposes by obscuring relationships and patterns that researchers require. Community forums and collaborative platforms may struggle to allow for meaningful discussions about health topics while protecting user anonymity and sensitive information. The inability to safely share and analyze healthcare data may impede medical research advancement and limiting opportunities to improve patient outcomes.

Cloud-native and high-volume environments may also face performance and scalability issues, particularly with handling data security and sensitive information. Certain tokenization approaches may introduce processing delays that affect user experience and system responsiveness. Database-dependent systems may require extensive infrastructure resources to maintain acceptable performance levels as data volumes grow. Multi-tenant environments may also fall short in maintaining data isolation while providing efficient tokenization services across different organizations. These performance limitations may hinder healthcare organizations from fully leveraging cloud-based services and modern IT architectures for data protection.

There is a continuing need for data protection solutions that provide enhanced security without compromising system performance, scalability, or functionality. Desirably, such solutions would eliminate reliance on centralized vaults while maintaining format-preserving capabilities for legacy system compatibility, allow for seamless interoperability across healthcare platforms while preserving data relationships for analytics, provide comprehensive regulatory compliance capabilities with immutable audit trails, and support high-performance operations in cloud-native environments without introducing processing bottlenecks or single points of failure.

### SUMMARY

In concordance with the instant disclosure, data protection solutions that provide enhanced security without compromising system performance, scalability, or functionality, have surprisingly been discovered.

The present technology includes systems and processes that relate to vaulted and vaultless tokenization architectures for protecting sensitive data across distributed computing environments, such as healthcare information systems, community platforms, and enterprise applications. The present technology may apply format-preserving cryptographic transformations without reliance on centralized token storage mechanisms to allow for compliant data processing, analytics capabilities, and cross-system interoperability while maintaining data utility and operational performance. The present technology improves upon certain tokenization systems by eliminating reliance on centralized vault architectures that may create performance bottlenecks and scalability limitations, while providing enhanced format-preserving cryptographic transformations that may allow for compliant data processing across healthcare information systems, enterprise applications, and community platforms. It should be appreciated that the present technology's use of vaultless tokenization may enhance data communication without compromising data utility, analytical capabilities, or operational performance in cloud-native distributed computing environments.

The present technology may also find applicability in various contexts, including distributed computing environments for financial services, such as payment processing, banking and investments, insurance, enterprise and government identity, educational institution, e-commerce and supply chain management, online community, professional networking, and dating platforms, cloud multi-tenant, legal, regulatory, and other transactions or document storage scenarios. The present technology contemplates the use of various applications and may be implemented and described herein through distributed computing environments that provide healthcare-based services. It should be understood that the present technology is not limited to healthcare-based transactions and may also be used in the above-mentioned and other circumstances. The present description of healthcare-based transactions for patients and medical providers provides an illustrative example of the present technology that is non-limiting and used solely as a model in describing the present technology.

In certain embodiments, a system for protecting sensitive data with vaultless tokenization across a distributed computing environment is provided. The system may include a processor and a memory in communication with the processor, where the memory may include a tokenization application programming interface (API), an encryption module, a tokenization engine, a key management module, and an enforcement module. The tokenization API may receive sensitive data from the distributed computing environment through a network. The encryption module may receive the sensitive data and apply a format-preserving cryptographic transformation to the sensitive data, thereby creating encrypted data while preserving a data format and a length characteristic of the sensitive data. The tokenization engine may receive the encrypted data from the encryption module, generate a format-preserving token that may include a structural characteristic based on the sensitive data, and provide the format-preserving token to the tokenization API. The key management module may process the encrypted data and the format-preserving token, generate a cryptographic key, and provide the cryptographic key to the tokenization API. The enforcement module may apply an authorization rule for access control to the format-preserving token and the cryptographic key based on a user role and a classification of the sensitive data. The tokenization API may provide the format-preserving token and the cryptographic key to the distributed computing environment based on the user role and the classification of the sensitive data.

In certain embodiments, a method for protecting sensitive data with vaultless tokenization across a distributed computing environment is provided. The method may include a step of providing a processor, a memory in communication with the processor, the memory including a tokenization application programming interface (API), an encryption module, a tokenization engine, a key management module, and an enforcement module. The method may include a step of receiving the sensitive data from the distributed computing environment via the tokenization API through the network. The method may include a step of applying the format-preserving cryptographic transformation to the sensitive data via the encryption module, thereby creating the encrypted data while preserving the data format and the length characteristic of the sensitive data. The method may include a step of generating the format-preserving token via the tokenization engine, where the format-preserving token may include the structural characteristic based on the sensitive data. The method may include a step of providing the format-preserving token to the tokenization API. The method may include a step of processing the encrypted data and the format-preserving token via the key management module to generate the cryptographic key. The method may include a step of providing the cryptographic key to the tokenization API. The method may include a step of applying the authorization rule for access control to the format-preserving token and the cryptographic key via the enforcement module based on the user role and the classification of the sensitive data. The method may include a step of providing the format-preserving token and the cryptographic key to the distributed computing environment via the tokenization API based on the user role and the classification of the sensitive data.

In certain embodiments, a non-transitory computer-readable storage medium for protecting sensitive data with vaultless tokenization across a distributed computing environment is provided. The processor instructions may cause the processor to receive sensitive data from the distributed computing environment via a tokenization API through a network. The processor instructions may cause the processor to apply a format-preserving cryptographic transformation to the sensitive data via an encryption module, creating encrypted data while preserving a data format and a length characteristic of the sensitive data. The processor instructions may cause the processor to generate a format-preserving token via a tokenization engine, where the format-preserving token may include a structural characteristic based on the sensitive data. The processor instructions may cause the processor to provide the format-preserving token to the tokenization API. The processor instructions may cause the processor to process the encrypted data and the format-preserving token via a cryptographic key module to generate a cryptographic key. The processor instructions may cause the processor to provide the cryptographic key to the tokenization API. The processor instructions may cause the processor to apply an authorization rule for access control to the format-preserving token and the cryptographic key via an enforcement module based on a user role and a classification of the sensitive data. The processor instructions may cause the processor to provide the format-preserving token and the cryptographic key to the distributed computing environment via the tokenization API based on the user role and the classification of the sensitive data. The processor instructions may cause the processor to monitor the format-preserving token and the cryptographic key via a security module to detect an anomalous activity. The processor instructions may cause the processor to store the format-preserving token in a data storage layer separated from the sensitive data.

Further areas of applicability will become apparent from the description provided herein. The description and specific examples in this summary are intended for purposes of illustration only and are not intended to limit the scope of the present disclosure. The drawings described herein are for illustrative purposes only of selected embodiments and not all possible implementations and are not intended to limit the scope of the present disclosure.

### DRAWINGS

FIG. 1 is a block diagram illustrating a system and a computer readable medium for protecting sensitive data with vaultless tokenization across a distributed computing environment;

FIG. 2 is a block diagram illustrating a system and a computer readable medium for protecting sensitive data with vaultless tokenization across a distributed computing environment;

FIG. 3 is a block diagram illustrating an embodiment of a system and a computer readable medium including an encryption algorithm and artificial intelligence capabilities;

FIG. 4 is a block diagram illustrating an embodiment of a system and a computer readable medium including an encryption module, tokenization engine, and key management module;

FIG. 5 is a block diagram illustrating an embodiment of a system and a computer readable medium including a security module, interoperability module, and compliance module;

FIG. 6 illustrates a graphical user interface including a tokenization application programming interface (API) for protecting sensitive data with vaultless tokenization across a distributed computing environment;

FIG. 7 illustrates a graphical user interface including a tokenization module for protecting sensitive data with vaultless tokenization across a distributed computing environment;

FIGS. 8A and 8B provide a flowchart illustrating an embodiment of a method for protecting sensitive data with vaultless tokenization across a distributed computing environment;

FIG. 9 provides a flowchart extending from FIGS. 8A and 8B and further illustrates a method for protecting sensitive data with vaultless tokenization across a distributed computing environment, including a data storage layer;

FIG. 10 provides a flowchart extending from FIGS. 8A and 8B and further illustrates a method for protecting sensitive data with vaultless tokenization across a distributed computing environment, including a multi-tenant environment;

FIG. 11 provides a flowchart extending from FIGS. 8A and 8B and further illustrates a method for protecting sensitive data with vaultless tokenization across a distributed computing environment, including executing various encryption algorithms;

FIG. 12 provides a flowchart extending from FIGS. 8A and 8B and further illustrates a method for protecting sensitive data with vaultless tokenization across a distributed computing environment, including generating audit trails for maintaining compliance with healthcare regulations;

FIG. 13 provides a flowchart extending from FIGS. 8A and 8B and further illustrates a method for protecting sensitive data with vaultless tokenization across a distributed computing environment, including a security module;

FIG. 14 provides a flowchart extending from FIGS. 8A and 8B and further illustrates a method for protecting sensitive data with vaultless tokenization across a distributed computing environment, including processing blocks of data;

FIG. 15 provides a flowchart extending from FIGS. 8A and 8B and further illustrates a method for protecting sensitive data with vaultless tokenization across a distributed computing environment, including generating a map of format-preserving tokens; and

FIGS. 16A and 16B provide a flowchart illustrating an embodiment of a method for secure user interaction and protecting sensitive data on a distributed computing environment.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of a steps presented is exemplary in nature, and thus, the order of a steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

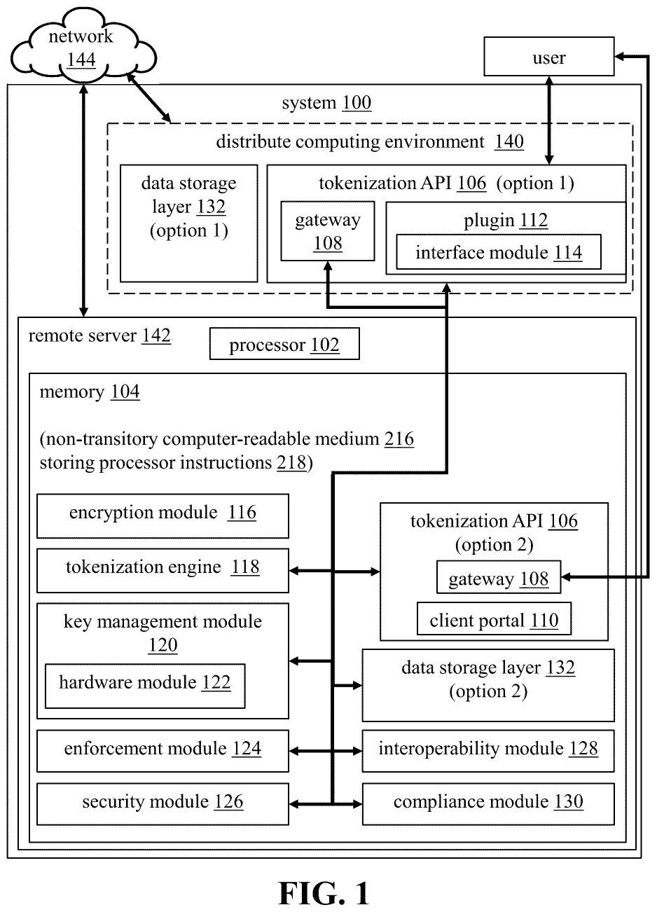

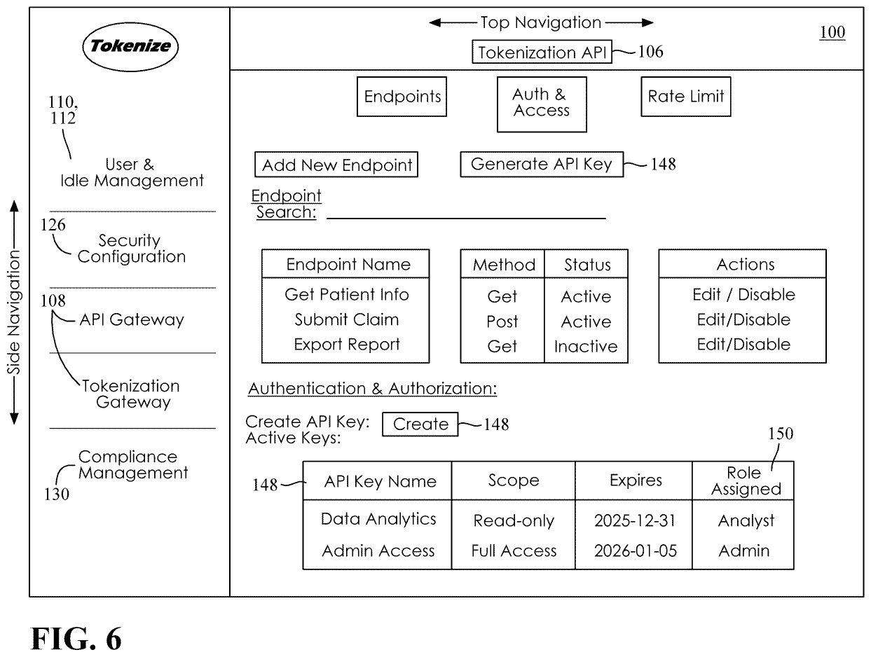

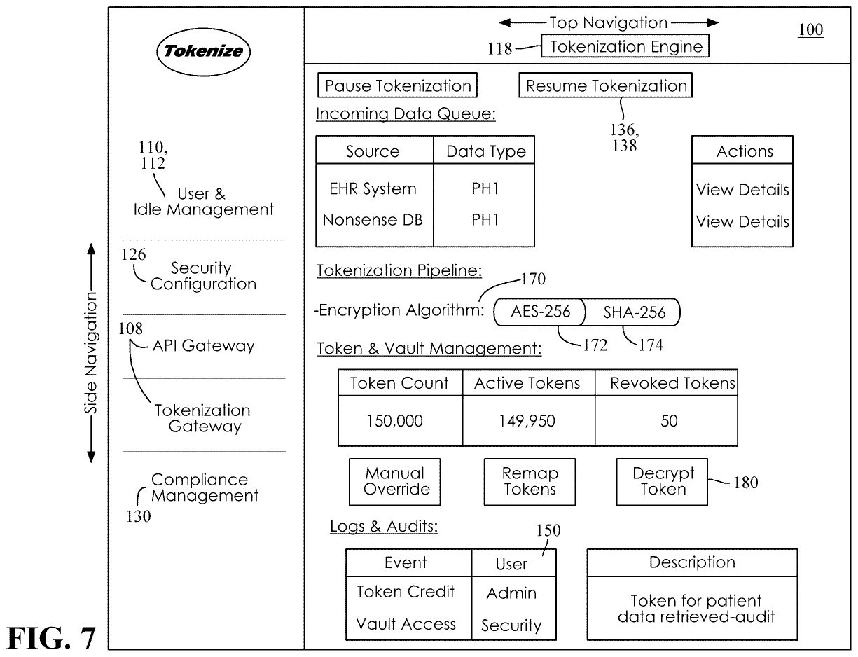

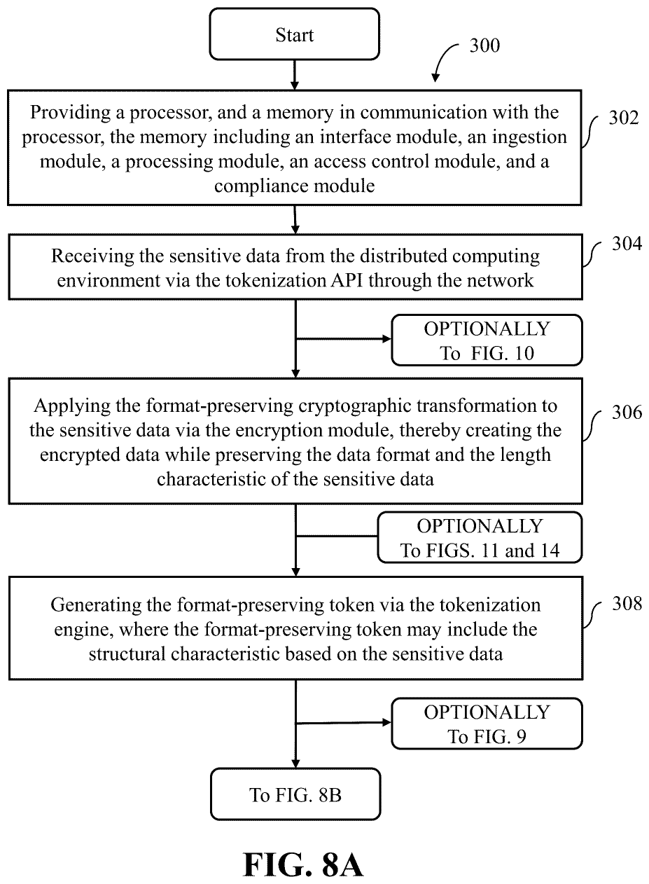

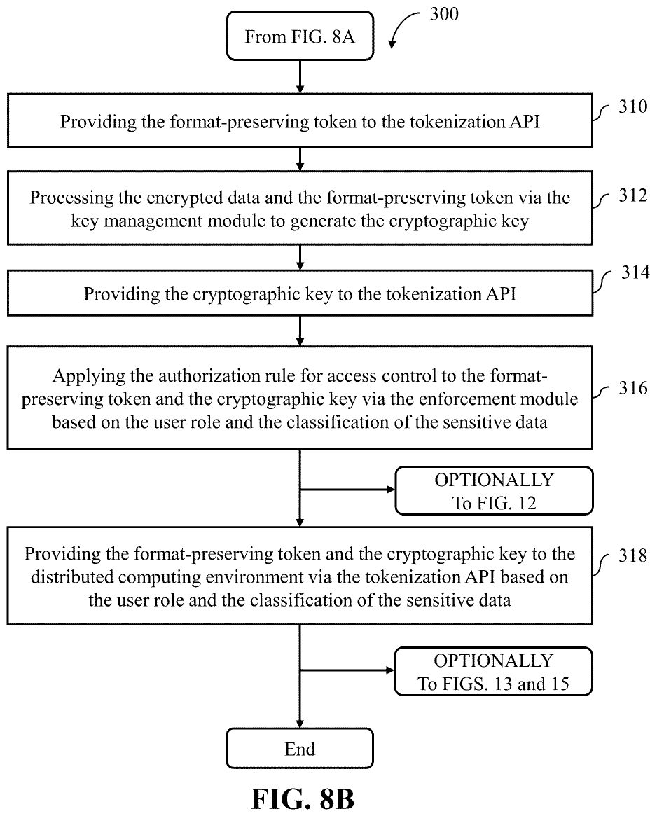

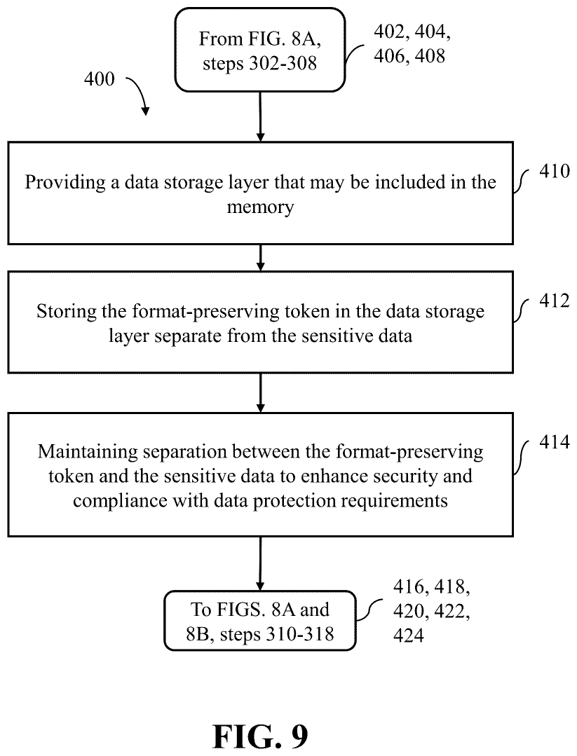

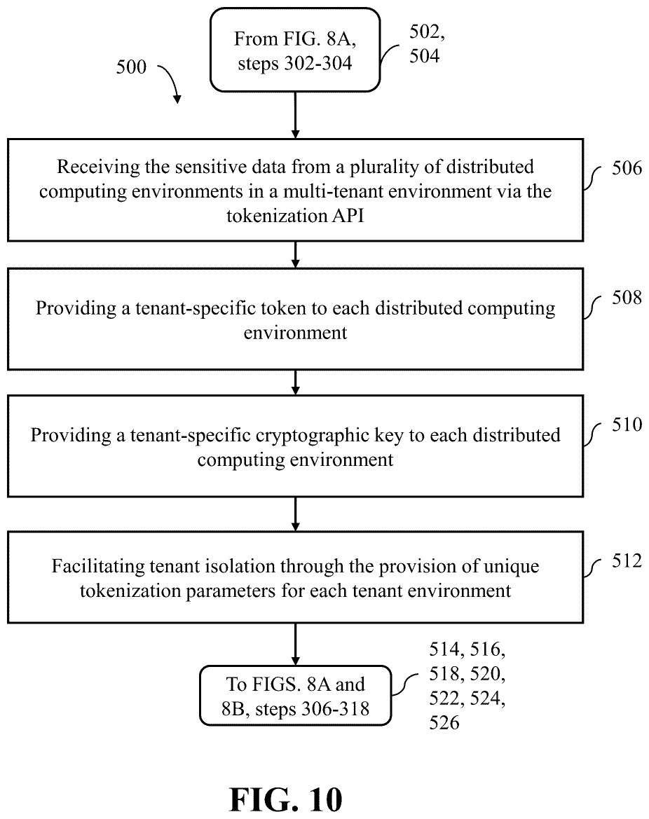

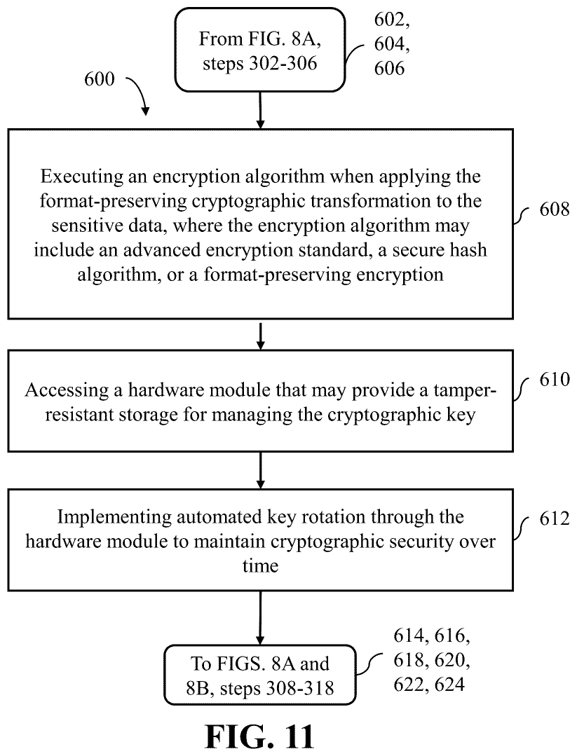

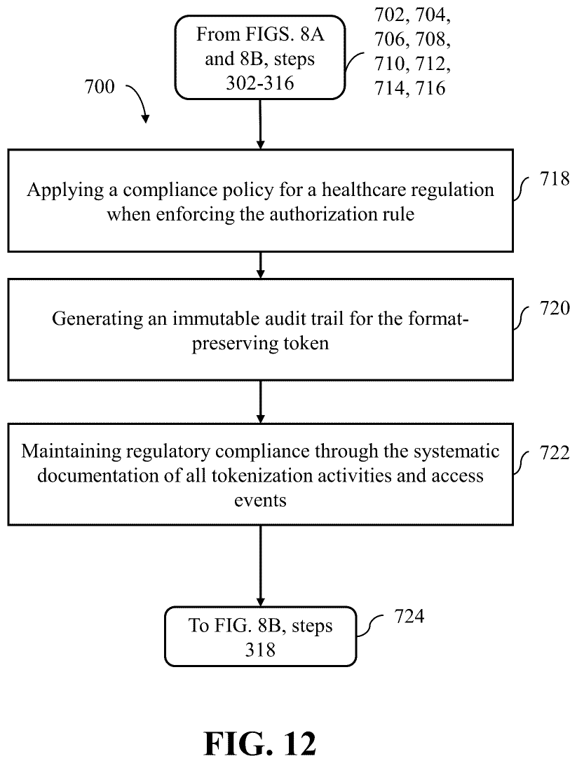

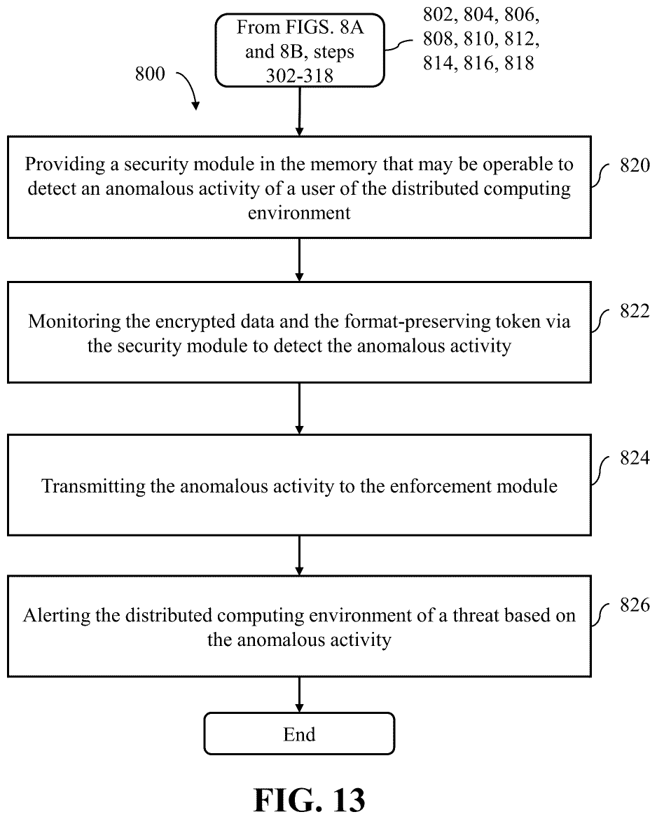

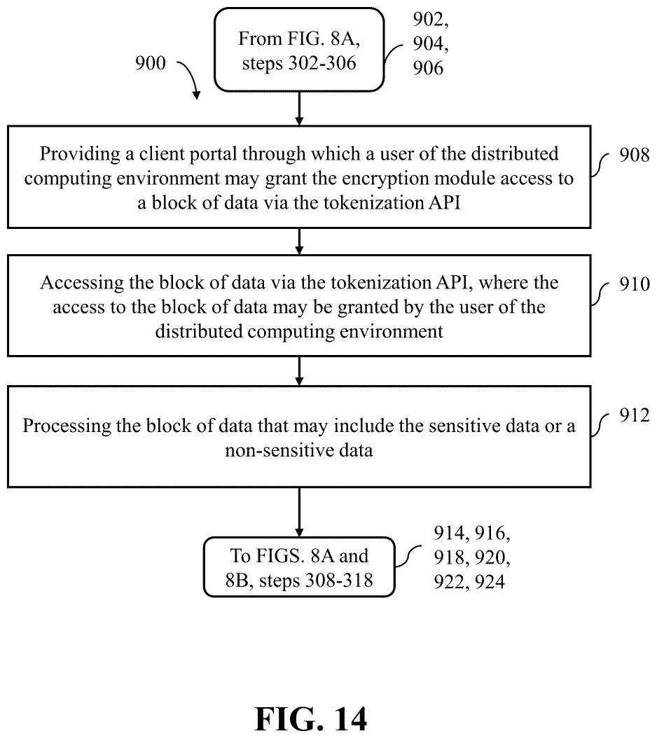

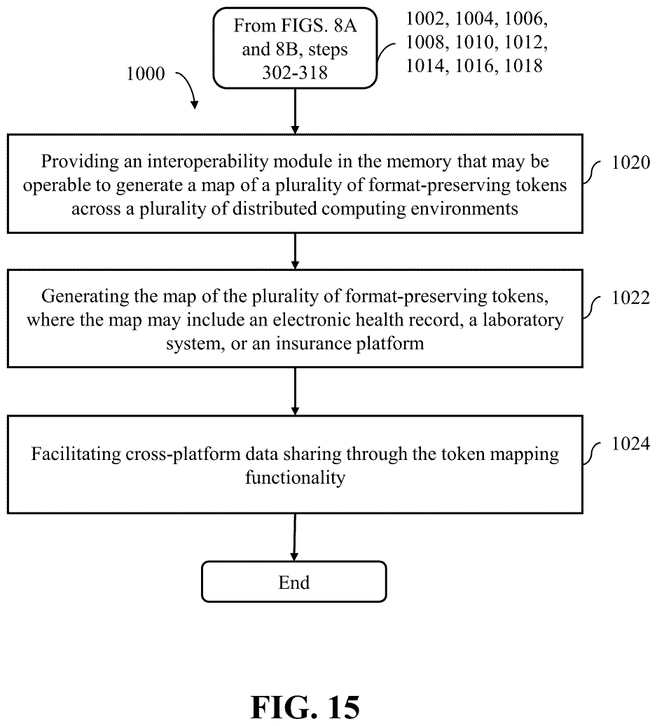

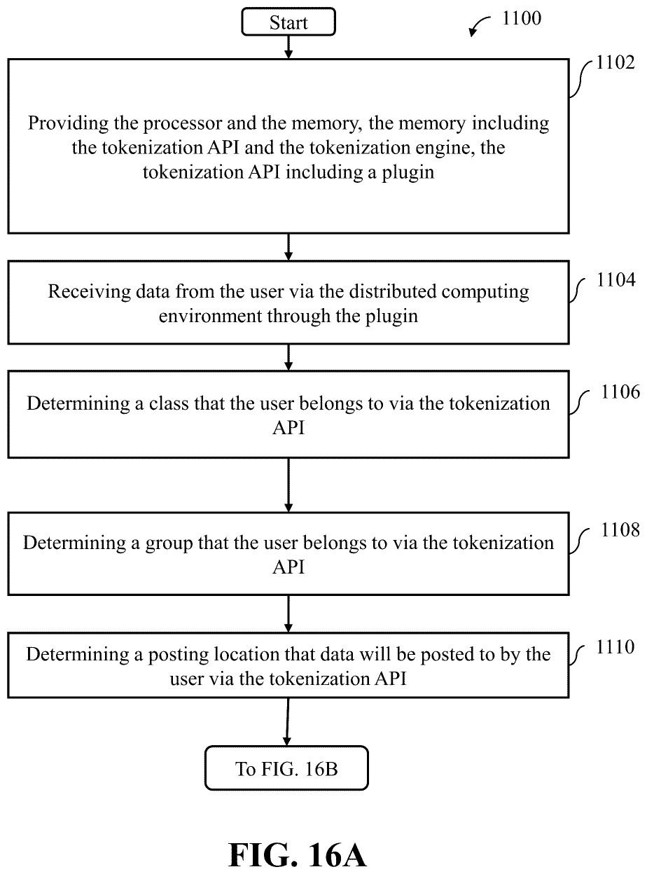

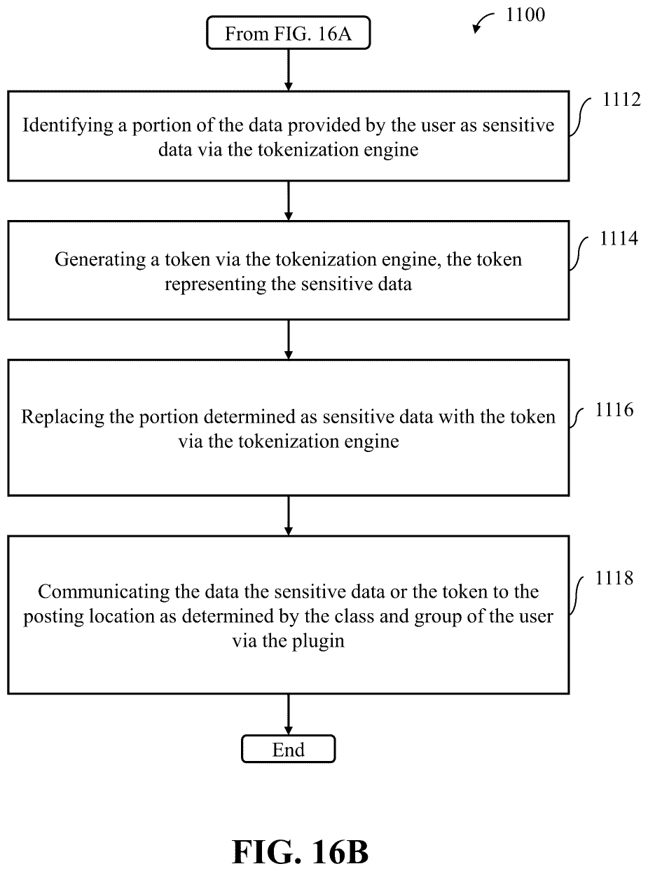

The present technology provides a system 100 and non-transitory computer-readable storage medium 216 for protecting sensitive data with vaultless tokenization across a distributed computing environment, aspects of which are shown generally in accompanying FIGS. 1-7. A method 300 for protecting sensitive data with vaultless tokenization across a distributed computing environment is also provided, aspects of which are shown in FIGS. 8A and 8B. A method 400 for protecting sensitive data with vaultless tokenization across a distributed computing environment is also provided, aspects of which are shown in FIG. 9. Another method 500 for protecting sensitive data with vaultless tokenization across a distributed computing environment is provided, aspects of which are shown in FIG. 10. Another method 600 for protecting sensitive data with vaultless tokenization across a distributed computing environment is provided, aspects of which are shown in FIG. 11. And another method 700 for protecting sensitive data with vaultless tokenization across a distributed computing environment is also provided in FIG. 12. Another method 800 for protecting sensitive data with vaultless tokenization across a distributed computing environment is also provided, aspects of which are shown in FIG. 13. Yet another method 900 for protecting sensitive data with vaultless tokenization across a distributed computing environment is also provided, aspects of which are shown in FIG. 14. And yet another method 1000 for protecting sensitive data with vaultless tokenization across a distributed computing environment is provided, aspects of which are shown in FIG. 15. And a method 1100 for secure user interaction and protecting sensitive data on a distributed computing environment is provided, aspects of which are shown in FIGS. 16A and 16B.

The system 100 and methods 300, 400, 500, 600, 700, 800, 900, 1000, and 1100 allow an organization to protect sensitive data 134 through vaulted and vaultless tokenization across distributed computing environments while maintaining format-preserving cryptographic capabilities. As shown in FIGS. 1-7, the system 100 may include a processor 102 and a memory 104 in communication with the processor 102. The memory 104 may include a tokenization application programming interface (API) 106 including a gateway 108, a client portal 110, a plugin 112, and an interface module 114, the memory 104 further including an encryption module 116, a tokenization engine 118, a key management module 120 including a hardware module 122, an enforcement module 124, a security module 126, an interoperability module 128, a compliance module 130, and a data storage layer 132.

The processor 102 may control the system 100 to execute various modules and components for protecting data including sensitive data 134 with vaulted tokenization 136 and vaultless tokenization 138 across a distributed computing environment 140. The processor 102 may operate in conjunction with the data storage layer 132 or other storage infrastructure services now available or later developed to provide secure tokenization capabilities. The processor 102 may be located locally on the system 100 or a remote server 142 accessed via a network 144. The remote server 142 may be the central hub of the system 100, containing the processor 102 and memory 104 that store and execute the modules necessary for tokenizing data. One skilled in the art will also appreciate that the processor 102 may include one or more processors 102 and may process information and execute the various instructions or operations, as described herein. For example, the processor 102 may include processing circuitry such as a central processing unit (CPU), a microprocessor, a microcontroller, a system-on-a-chip, a digital signal processor (DSPs), field-programmable gate arrays (FPGAs), application-specific integrated circuits (ASICs), and/or a processor 102 based on a multi-core processor architecture. One or more processors 102 may mean a single processor or multiple processors in a single processing unit, e.g., a central processing unit, or multiple processing units, e.g., a central processing unit and a graphics processing unit, or a central processing unit and a memory 104 manager. The processor 102 may include multiple processors 102 where one processor 102 is capable of executing one or more of the elements described in this disclosure, and a subsequent processor 102 or processors 102 may execute other elements as described herein, capable of executing all elements only in combination. One or more of the processors 102 may be remote from the at least one local system 100 server.

The memory 104 may be in communication with the processor 102 and may include both volatile and non-volatile memory components. The memory 104 may store program instructions, operating software, and applications required for tokenizing data. The memory 104 may include additional modules that work together to provide comprehensive document management capabilities for vaulted tokenization 136 and vaultless tokenization 138. The memory 104 may implement secure memory handling, e.g., with cryptographic memory wiping after processing to ensure sensitive data 134 does not persist in temporary storage. The memory 104 may store or otherwise include one or more data storage layer 132. The memory 104 can include one or more memories, may include a memory subsystem, and of any type suitable to the system 100 and can be implemented using any suitable volatile or nonvolatile data storage technology such as a semiconductor-based memory device, a magnetic memory device, an optical memory, a fixed memory, and/or a removable memory. For example, the memory 104 may include any combination of random-access memory (RAM), read only memory (ROM), static storage such as a magnetic or optical disk, a hard disk drive (HDD), or any other type of non-transitory machine or computer readable media.

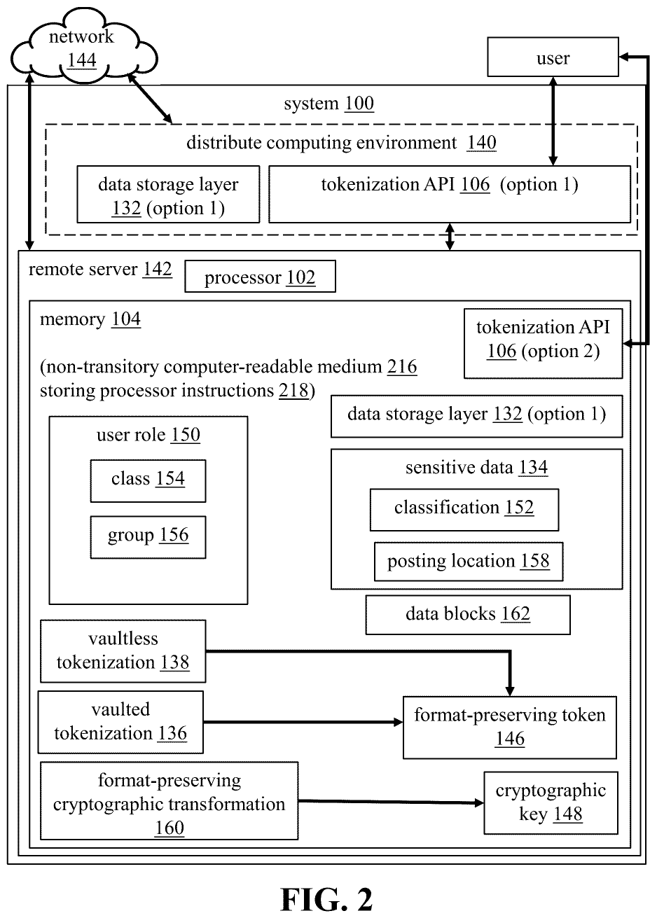

As shown in FIGS. 1 and 2, the tokenization API 106 may receive sensitive data 134 from the distributed computing environment 140 through the network 144. The tokenization API 106 may provide a format-preserving token 146 and a cryptographic key 148 to the distributed computing environment 140 based on a user role 150, e.g., an administrator, patient, healthcare provider or practitioner, and a classification 152 of the sensitive data 134, e.g., highly sensitive personally identifiable information (PII), moderately sensitive PII, etc. For example, the format-preserving token 146 may act as a substitute for sensitive data 134 that maintains the original format of the sensitive data 134, allowing the format-preserving token 146 to be used in existing systems without needing changes to databases or applications. The cryptographic key 148, e.g., a string of bits used with a cryptographic algorithm to encrypt and decrypt the sensitive data 134, may verify, identity, or digitally sign information as required by the system 100. The distributed computing environment 140 may include healthcare platforms, financial services such as payment processing, banking and investments, insurance, enterprise and government identity, educational institution, e-commerce and supply chain management, online community, professional networking, and dating platforms, cloud multi-tenant, legal, regulatory, and other transactions or document storage scenarios.

The tokenization API 106 architecture may be implemented through multiple deployment strategies that accommodate the diverse distributed computing environment 140 and other organizational requirements. An implementation of the tokenization API 106 may include a plugin 112, e.g., a software component that adds specific functionality to an existing application, that may allow for the tokenization API 106 to operate as a software component that may be installed directly within existing distributed computing infrastructure of the distributed computing environment 140, as shown in FIG. 1, option 1, providing seamless integration with healthcare platforms, enterprise systems, and community forums. This plugin 112 may allow the tokenization API 106 to analyze incoming data streams in real-time containing sensitive data 134 and automatically determine appropriate tokenization policies based on the determination of the class 154 of the user, the group 156 that the user belongs to, and the intended posting location 158 where sensitive data 134 may be transmitted or stored. The plugin 112 may evaluate these contextual factors dynamically to apply format-preserving cryptographic transformation 160 and vaultless tokenization 138 processes without requiring manual intervention or external system 100 dependencies.

The tokenization API 106 may alternatively be implemented through a client portal 110, through cloud-based architecture that provides the user with secure web-based access to tokenization services via the network 144, as shown in FIG. 1, option 2. The client portal 110 may allow for distributed computing environments 140 and individual users to upload blocks of data 162, e.g., blocks of raw data that include sensitive data 134, through the client portal 110, where the tokenization API 106 may analyze the blocks of data 162 to identify sensitive data 134 and other personally identifiable information that requires protection. For example, the client portal 110 may provide flexibility for batch processing scenarios and may support multiple data formats 190 while maintaining compliance with regulations and data protection requirements. Both implementation approaches may leverage the tokenization engine 118 and the key management module 120 components while providing different interaction between various modules that may be selected based on the organizational security policies, technical infrastructure capabilities, and user workflow requirements of the distributed computing environment 140. It should be understood that one skilled in the art may employ a combination of the architectures described herein, including any hybrid model that utilizes portions of, or aspects of the plugin 112 stored locally on the distributed computing environment 140, or the online or cloud-based tokenization API 106 through the client portal 110.

As shown in FIG. 1, the gateway 108 may serve as the primary entry point for receiving sensitive data 134 from the distributed computing environment 140 through secure communication via the network 144. In other words, the gateway 108 may act as a reverse proxy between an application located on the distributed computing environment 140 and the tokenization API 106. For example, the gateway 108 may implement multiple authentication protocols including validation by JavaScript Object Notation (JSON) Web Token (JWT) validation, e.g., a token used to securely transmit information, and authentication through a Transport Layer Security (TLS) certificate, e.g., a certificate used to verify the identity of a server and/or client to prevent “man-in-the-middle” attacks, to establish secure communication channels with client applications. The gateway 108 may route incoming tokenization requests to appropriate modules while maintaining stateless operations that enhance scalability across a multi-tenant environment 164. For example, the gateway 108 may enforce rate limiting policies and request validation procedures to prevent unauthorized access attempts and ensure system 100 stability. The gateway 108 may allow the tokenization API 106 to receive the sensitive data 134 from a plurality of distributed computing environments 140 in a multi-tenant environment 164 and provides a tenant-specific token 166 and a tenant-specific cryptographic key 168 to each distributed computing environment 140. The gateway 108 may log all incoming requests and responses for audit trail 196 purposes, e.g., recording events, and transactions within the system 100, while maintaining compliance with healthcare data protection regulations.

The client portal 110 may serve as a web-based or cloud-based interface through which the user of the distributed computing environment 140 may grant access permissions to blocks of data 162 via the tokenization API 106. The client portal 110 may include user authentication mechanisms that verify identity credentials before allowing access to tokenization services and data management functionalities. For example, the client portal 110 may display tokenization status information, processing statistics, and compliance reports to authorize the user through customizable dashboard interfaces. The client portal 110 may allow the user to configure policies for classification 152 of sensitive data 134 and access control rules that determine how the sensitive data 134 may be processed and protected. It should be understood that the client portal 110 may maintain session management capabilities that automatically terminate inactive connections to prevent unauthorized access to sensitive configuration settings.

The plugin 112 may extend the functionality of existing healthcare applications by providing seamless integration with the system 100 without requiring modifications to underlying application architectures. For example, the plugin 112 may implement application programming interfaces that allow third-party software to invoke tokenization services directly from within the native operating environments of the distributed computing environment 140. The plugin 112 may support multiple data formats 190 and communication protocols to ensure compatibility with diverse healthcare information systems, e.g., electronic health records (EHR) 206 platforms. The plugin 112 may include configuration management, for example, tools that allow system 100 administrators to customize tokenization behaviors based on specific organizational requirements and compliance mandates. The plugin 112 may provide real-time status monitoring and error reporting capabilities that allow for proactive identification and resolution of integration issues. The plugin 112 may determine a posting location 158 that data will be posted to by the user, allowing for custom tokenization based on where the data including sensitive data 134 will be posted on the distributed computing environment 140. For example, the plugin 112 may determine that the sensitive data 134 will be posted to a private communication channel between a patient and a medical provider, and thus the level of tokenization will differ compared to a community-based communication channel that hosts multiple patients and third parties.

The interface module 114 may serve as the primary entry point for the plugin 112, and an external layer and interface for the system 100 and the point of interaction between a user and the system 100. The interface module 114 may implement protocols for sending and receiving sensitive data 134 and blocks of data 162 via the tokenization API 106. The interface module 114 may include authentication components, for example, validation via a JWT and TLS certificate authentication for high-security. The interface module 114 may be intuitive and user-friendly, for example, with custom user preferences and accessibility requirements, allowing the user to easily upload documents, sensitive data 134, or blocks of data 162 for later use, or allow the user to retrieve a pre-generated or uploaded document or data. The interface module 114 may receive documents from the user through secure upload mechanisms that generate secure upload uniform resource locators (URLs). The interface module 114 may generate unique identifiers for the user that encapsulate individual identity while protecting and hiding details about the identity of the user. The interface module 114 may implement an identifier that follows, for example, an alphanumeric format where components of the identifier may represent a property code, a birth year combination, a biometric hash, e.g., a one-way, non-reversible string of characters created by applying a cryptographic algorithm to biometric data such as a fingerprint or face scan, or a checksum, e.g., a unique string of characters that acts as a “fingerprint” for a file, used to verify its integrity and detect errors. The interface module 114 may combine biometric verification with government identification validation to create a system 100 for tokenization that militates against discrimination and improves efficiency. The interface module 114 may allow for mobile biometric verification to assist transactions for users that may allow for remote validation.

The interface module 114 may interact with hardware including various output devices that may display a representation of the interface module 114 for observation by the user, where such an output device may include, for example, one or more computer screens, speakers, tablet screens, television screens, smartphone screens, printers, or other view/audio ports. The interface module 114 may include, for example, a graphical user interface that can be displayed in various ways, for example, via a desktop application, smartphone, tablet, tv, mobile application, web interface, or API, and may interface with mobile short message service (SMS), social platforms, or messaging applications.

Determining a class 154 via the tokenization API 106 may involve analyzing the user role 150, e.g., credentials, to establish appropriate access privileges within the distributed computing environment 140. The process of determining the class 154 may include, for example, evaluating user authentication tokens and organizational hierarchies to categorize the user as a patient, healthcare provider, administrative personnel, or other designated user role 150. The class 154 may influence tokenization policies and data access controls by defining which types of sensitive data 134 may be accessed or processed by specific user categories. The determination of the class 154 may incorporate multi-factor authentication requirements and privilege escalation procedures to ensure that the user may only access data appropriate to the designated user role 150. The class 154 may therefore be dynamically updated based on changes in user status, organizational assignments, or regulatory compliance requirements as required by the distributed computing environment 140.

Determining a group 156 via the tokenization API 106 may involve evaluating the class 154, e.g., user affiliations, and sensitive data 134 subject matter to establish contextual relationships that influence tokenization policies. The process of determining the group 156 may include, for example, analyzing user membership in healthcare specialty areas, patient condition categories, or research cohorts to allow for appropriate data sharing and protection measures. For example, the group 156 may define data visibility rules that allow the user to access sensitive data 134 related to designated areas of responsibility while maintaining privacy protections for unrelated data. The determination of the group 156 may support group 156 hierarchical structures that allow for graduated access controls based on organizational reporting relationships and functional responsibilities. It should be understood that the group 156 may incorporate temporal access controls that automatically adjust permissions based on project timelines, treatment episodes, or research study durations as required by the distributed computing environment 140.

Determining sensitive data 134 via the tokenization API 106 may involve applying artificial intelligence (AI) 178, including natural language processing (NLP) 184 algorithms and rules for classification 152 to identify sensitive data 134, e.g., PII and protected health information within user-generated content. For example, the process of detecting the sensitive data 134 may include analyzing text patterns, data formats 190, and contextual indicators to distinguish between sensitive and non-sensitive data 134 elements requiring different levels of protection. The identification of the sensitive data 134 may include other AI 178 such as machine learning (ML) models 186 trained on healthcare data patterns to improve accuracy in detecting sensitive content across diverse data formats 190 and communication channels. For example, the classification 152 of the sensitive data 134 may include categorizing detected data elements according to regulatory frameworks including the Health Insurance Portability and Accountability Act (HIPAA), the General Data Protection Regulation Act (GDPR), and the Health Information Technology for Economic and Clinical Health Act (HITECH) requirements to ensure appropriate protection measures may be applied. Detecting sensitive data 134 may include operating in real-time to provide immediate protection for sensitive data 134 as may be entered or transmitted through the system 100.

As shown in FIGS. 1, 3, and 4, the encryption module 116 may receive the sensitive data 134 and apply a format-preserving cryptographic transformation 160 to the sensitive data 134, thereby creating encrypted data 188 while preserving a data format 190 and a length characteristic 192 of the sensitive data 134. The encryption module 116 may implement the encryption algorithm 170 including an advanced encryption standard (e.g., AES-256) 172, a secure hash algorithm (e.g., SHA-256) 174, or a format-preserving encryption 176, for example, to ensure that encrypted data 188 maintains structural compatibility with legacy healthcare systems and external databases. For example, the encryption module 116 may utilize initialization vectors, e.g., random, unpredictable, and non-secret bit strings, or cryptographic salts, e.g., unique, random string of data added to a password before it is hashed to enhance security, so that identical sensitive data 134 values produce different encrypted outputs, preventing pattern analysis attacks. The encryption module 116 may coordinate with the key management module 120 to obtain appropriate cryptographic keys 148 and may rotate cryptographic parameters according to established security policies. It should be understood that the encryption module 116 may maintain audit logs of all encryption operations while ensuring that cryptographic processes do not introduce processing delays that may affect system 100 performance.

The encryption module 116 may execute the encryption algorithm 170 in order to implement multiple cryptographic approaches, e.g., deterministic and probabilistic encryption methods to support different use cases and security requirements within the distributed computing environment 140. Deterministic encryption methods may include producing the same cyphertext each time a specific piece of text is encrypted, while in contract, probabilistic encryption may include producing a different cipher text each time a certain piece of text is encrypted. For example, the encryption algorithm 170 may utilize a format-preserving cryptographic transformation 160 technique, e.g., securing data by encrypting the data while keeping the original form, structure, and strength of the date, maintaining data type characteristics and structural relationships to allow for analytical processing of encrypted data 188 sets without compromising security. In another example, the encryption algorithm 170 may incorporate key derivation functions, e.g., a cryptographic algorithm that generates one or more secret keys from a shared secret such as a password, and cryptographic hashing, e.g., converting data to a string of characters that are difficult to reverse, to generate unique encryption parameters for each data transformation operation. It should be understood that the encryption algorithm 170 may support algorithm agility through configurable cipher suites, e.g., a set of cryptographic algorithms used to secure a network connection, that may be updated to address emerging cryptographic threats and regulatory requirements, and may implement resistance measures against side-channel attacks, e.g., exploiting information leaked from the physical characteristics of a distributed computing environment 140, such as power consumption, timing, or electromagnetic emissions, to gain unauthorized access to sensitive data. In other words, the encryption algorithm 170 may militate against unauthorized extraction of the cryptographic key 148 or sensitive data 134 through timing or power analysis attacks.

The tokenization engine 118 may receive the encrypted data 188 from the encryption module 116, generate a format-preserving token 146 that may include a structural characteristic based on the sensitive data 134, and provide the format-preserving token 146 to the tokenization API 106. For example, the tokenization engine 118 may implement vaultless tokenization 138 algorithms that generate tokens dynamically without requiring centralized storage of token-to-data mappings. In other words, the tokenization engine 118 may tokenize sensitive data 134 without storing the original sensitive data 134 in a central “vault” database, and therefore without the need to maintaining a table that maps the token back to the original data for subsequent searches or lookups. The tokenization engine 118 may generate tokens that maintain referential integrity and relational characteristics that allow for analytical processing and data correlation across multiple healthcare systems. It should be appreciated that the tokenization engine 118 may incorporate randomization techniques and cryptographic functions to ensure that tokens may not be reverse-engineered to reveal original sensitive data 134 values. The tokenization engine 118 may support multiple token formats and generation strategies to accommodate diverse healthcare data types as required by the distributed computing environment 140, including integration requirements.

The tokenization engine 118 may tokenize sensitive data 134 through vaulted tokenization 136 by implementing database-driven approaches that maintain a persistent map 194 between original sensitive data 134 and generated tokens within secure storage repositories. The process of vaulted tokenization 136 may include utilizing the data storage layer 132 or other encrypted databases with role-based access controls to ensure that the token map 194 may only be accessed by authorized system 100 components and personnel. The vaulted tokenization 136 may implement backup and recovery procedures to ensure that the token map 194 remains available during system 100 maintenance and disaster recovery scenarios. For example, the vaulted tokenization 136 may support bulk tokenization operations for large healthcare datasets while maintaining transaction integrity and system 100 performance. It should be appreciated that the process of vaulted tokenization 136 may include providing audit trail 196 capabilities that track all token creation, retrieval, and modification operations for compliance and security monitoring purposes.

The tokenization engine 118 may tokenize data through vaultless tokenization 138, e.g., implementing algorithmic approaches that generate tokens dynamically using cryptographic functions without requiring persistent storage of the token map 194. The process of vaultless tokenization 138 may include utilizing deterministic algorithms, for example, algorithms that produce consistent tokens for identical input data while ensuring that token generation may not reveal information about the original sensitive data 134. It should be appreciated that vaultless tokenization 138 may eliminate single points of failure and performance bottlenecks associated with centralized token vault architectures while maintaining format-preserving characteristics. The vaultless tokenization 138 may support distributed deployment across one or more distributed computing environments 140 and other cloud-native environments without requiring coordination between instances of tokenization or shared storage resources within the data storage layer 132. It should also be appreciated that the process of vaultless tokenization 138 may provide enhanced scalability and reduced operational overhead compared to vault-based approaches while maintaining equivalent security protections.

The tokenization engine 118 may detokenize data via the detokenization process 180 by implementing reverse transformation processes that recover original sensitive data 134 from tokens using an appropriate cryptographic key 148 and algorithmic parameters. For example, the detokenization process 180 may implement strict access controls and authorization checks to ensure that sensitive data 134 may only be recovered by authorized system 100 components and the user with appropriate permissions. The detokenization process 180 may support both vaulted and vaultless approaches depending on the tokenization method originally used to protect the sensitive data 134. The detokenization process 180 may maintain an audit trail 196 of all data recovery operations and may implement rate limiting to prevent unauthorized bulk extraction of sensitive data 134. The detokenization process 180 may coordinate with enforcement policies of the system 100 to restrict recovered sensitive data 134 to only be used for authorized purposes and may be automatically re-protected after processing.

The tokenization engine 118 may alter data via data masking 182, e.g., implementing partial obfuscation techniques that preserve sensitive data 134 utility for analytical purposes while protecting sensitive elements within healthcare datasets. The process of data masking 182 may apply different masking strategies, for example, character substitution, format preservation, and statistical distribution maintenance to ensure that masked data remains useful for testing and development purposes. The tokenization engine 118 may utilize data masking 182 to implement consistent rules relating to referential integrity across related data elements while preventing correlation attacks that could reveal sensitive data 134, for example, generic or descriptive phrases or terminology that does not indicate the source of the sensitive data 134. The process of data masking 182 may support reversible and irreversible masking approaches depending on data protection requirements and intended use cases. The data masking 182 may coordinate with tokenization processes to provide layered protection strategies that combine multiple data transformation techniques.

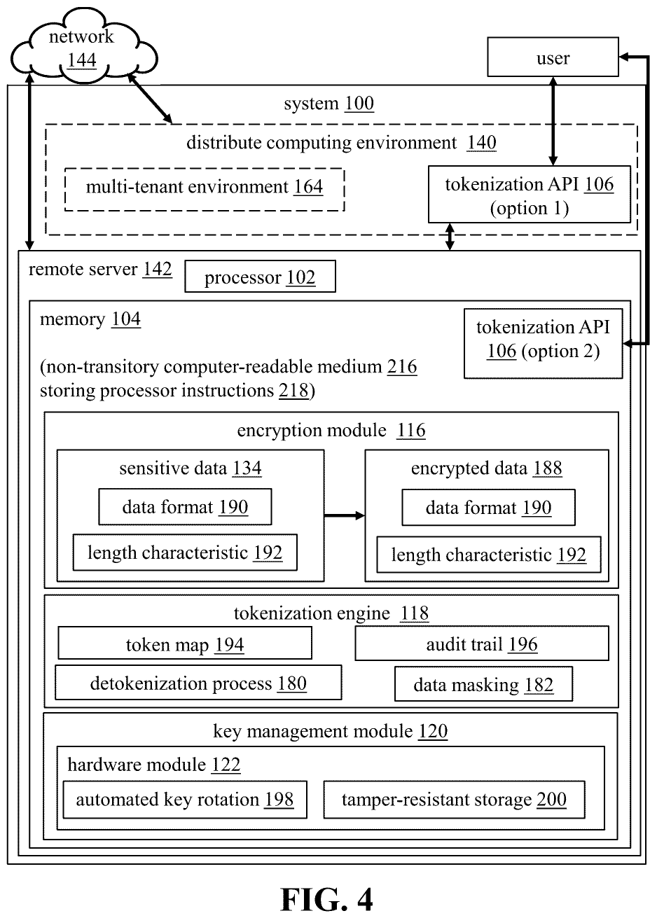

As shown in FIGS. 1 and 4, the key management module 120 may process the encrypted data 188 and the format-preserving token 146, generate a cryptographic key 148, and provide the cryptographic key 148 to the tokenization API 106. The key management module 120 may implement automated key rotation 198 procedures, e.g., automatically generate, distribute, and revoke cryptographic keys 148 on a regular schedule or in response to specific events, and other hierarchical key structures via the hardware module 122 so that the cryptographic key 148 maintains appropriate security-related strength throughout the operational lifecycle. The key management module 120 may coordinate with the security module 126 and other cloud-based key management services to ensure that the cryptographic key 148 may be generated, stored, and distributed according to best practices within an industry. For example, the key management module 120 may support multiple key derivation algorithms, e.g., generating secure keys from a secret input, such as a password or a master key, and may implement key escrow procedures to allow for authorized key recovery for compliance and audit trail 196 purposes. The key management module 120 may maintain cryptographic key 148 metadata, for example, creation timestamps, usage statistics, and expiration dates to support automated key lifecycle management.

The hardware module 122 may provide tamper-resistant storage 200 and processing capabilities for managing the cryptographic key 148 and performing sensitive operations within the system 100. For example, the hardware module 122 may implement Federal Information Processing Standards (FIPS) 140-2 Level 3 or higher security requirements so that cryptographic operations may be protected against physical and logical attacks, erasing sensitive data 134 upon instances of attempted tampering. The hardware module 122 may support automated key rotation 198 procedures that generate and distribute a new cryptographic key 148 according to predefined schedules and security policies. It should be appreciated that the hardware module 122 may provide secure random number generation and cryptographic algorithm execution within protected hardware environments. The hardware module 122 may maintain logs for an audit trail 196 of all cryptographic operations and may implement role-based access controls that restrict hardware module 122 access to the system 100 components and personnel.

The enforcement module 124 may apply an authorization rule for access control to the format-preserving token 146 and the cryptographic key 148 based on a user role 150 and a classification 152 of the sensitive data 134. The enforcement module 124 may implement policy-driven access controls that evaluate user attributes, data classification 152, and contextual factors to determine appropriate authorization decisions. For example, the enforcement module 124 may support fine-grained permissions, e.g., allowing access to be granted or denied based on a wide range of factors such as the relationship of user role 150 to the sensitive data 134, system 100 events, and contextual conditions, rather than just broad access, to control different types of operations including tokenization, detokenization, key access, and data export capabilities. The enforcement module 124 may coordinate with various identity management systems and authentication services to validate user credentials and maintain current user roles 150. It should be appreciated that the enforcement module 124 may implement real-time policy evaluation and may cache authorization decisions to optimize system 100 performance while maintaining security requirements.

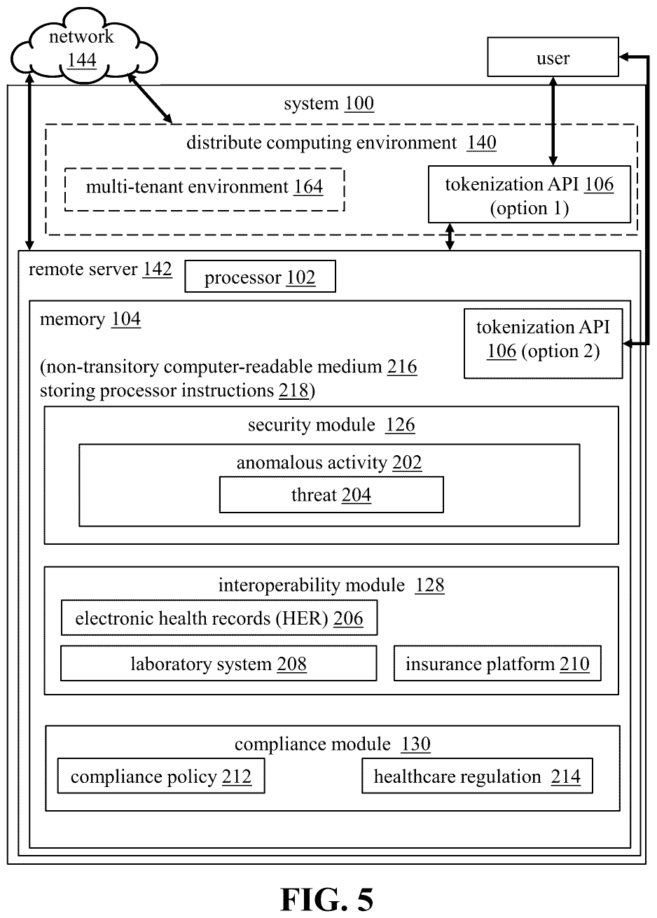

As shown in FIGS. 1 and 5, the security module 126 may monitor system 100 operations and detect an anomalous activity 202 that may indicate a security threat 204 or unauthorized access attempts within the distributed computing environment 140. For example, the security module 126 may implement behavioral analytics and ML algorithms to identify unusual patterns in tokenization requests, data access patterns, and system 100 usage that may indicate potential security incidents. The security module 126 may coordinate with various external systems, e.g., security information and event management (SIEM) systems to correlate security events across multiple system 100 components and external security tools. The security module 126 may implement automated responses to a threat 204 that may also temporarily restrict access or alert security personnel when suspicious activities are detected. In other words, the security module 126 may maintain intelligence feeds related to the security threat 204 and may update security monitoring rules to address emerging attack patterns and security vulnerabilities.

The interoperability module 128 may generate the map 194 of format-preserving tokens 146 across multiple distributed computing environments 140, e.g., an electronic health record (EHR) 206, a laboratory system 208, and an insurance platform 210 to allow for coordinated healthcare data sharing. For example, the interoperability module 128 may implement healthcare data standards including standards from Health Level Seven International (HL7) including fast healthcare interoperability resources (FHIR), and digital imaging and communications in medicine (DICOM) so that tokenized data may be exchanged between different distributed computing environments 140 while maintaining format compatibility. In other words, the interoperability module 128 may support cross-platform token synchronization that allow for the same sensitive data 134 to be consistently tokenized across different distributed computing environments 140 and organizations. The interoperability module 128 may coordinate with healthcare information exchanges and data sharing networks to allow for population health studies and collaborative research using tokenized datasets. It should be appreciated that the interoperability module 128 may implement data governance capabilities that track token usage across multiple distributed computing environments 140 and may enforce data sharing agreements between participating healthcare organizations.

The compliance module 130 may enforcement module is configured to apply a compliance policy 212 for a healthcare regulation 214 and generate an immutable audit trail 196 for the format-preserving token 146. For example, the compliance module 130 may implement regulatory compliance capabilities including the Health Insurance Portability and Accountability Act (HIPAA), the General Data Protection Regulation Act (GDPR), and the Health Information Technology for Economic and Clinical Health Act (HITECH) requirements to ensure that tokenization operations adhere to applicable healthcare data protection regulations. The compliance module 130 may generate an immutable audit trail 196 that documents all data access, tokenization, and detokenization operations for regulatory reporting and investigation purposes. In other words, the compliance module 130 may implement data retention policies that automatically archive or delete tokens and associated metadata according to regulatory requirements and organizational policies. For example, the compliance module 130 may support consent management capabilities that track patient authorization for data use and may enforce consent-based access controls. It should be understood that the compliance module 130 may provide the distributed computing environment 140 with compliance reporting features that generate standardized reports for regulatory audits and organizational compliance monitoring.

As shown in FIGS. 1 and 2, the data storage layer 132 may include: a local database located on the distributed computing environment 140, shown as the data storage layer 132 option 1 in FIG. 1; a database saved on a remote server and accessed via the network 144, labeled as the data storage layer 132, option 2 in FIG. 1, such as a cloud server; or a combination of a local and a remote database, as required by the system 100. The data storage layer 132 may also include, for example, a vector database or vector store for storing vectors generated or utilized by various modules including the tokenization API 106 and the security module 126, initialization vectors (IVs), feature vectors, or vector embeddings, e.g. flexible, meaning-based, probabilistic numerical representations of data that capture semantic meaning, allowing the system 100 to compare similarities between different types of data. The data storage layer 132 may also include a relational database, for example, data saved in a structured form, e.g. a structured query language (SQL) table, a comma-separated values (CSV) file, or in JavaScript object notation (JSON), or a JSON-related object or map, or object storage, or other forms of tabular input. The data storage layer 132 may also include a general storage database to store, for example, unstructured data such as HTML, text, raw transcripts, chat logs, images, audio files, or social media posts. The data storage layer 132 may save documents and sensitive data 134 on the blockchain for immutable document history, and integration with smart contract platforms for automated transactional events. It should be understood that the data storage layer 132 may employ separate or secondary encryptions as required to protect sensitive data 134, ensuring that the stored data remains secure and confidential when later retrieved by the user.

As shown in FIGS. 8A and 8B, a method 300 for protecting sensitive data 134 with vaultless tokenization 138 across a distributed computing environment 140 is provided. The method 300 may include a step 302 of providing a processor 102, a memory 104 in communication with the processor 102, the memory 104 including a tokenization application programming interface (API) 106, an encryption module 116, a tokenization engine 118, a key management module 120, and an enforcement module 124. The method 300 may include a step 304 of receiving the sensitive data 134 from the distributed computing environment 140 via the tokenization API 106 through the network 144. The method 300 may include a step 306 of applying the format-preserving cryptographic transformation 160 to the sensitive data 134 via the encryption module 116, thereby creating the encrypted data 188 while preserving the data format 190 and the length characteristic 192 of the sensitive data 134. The method 300 may include a step 308 of generating the format-preserving token 146 via the tokenization engine 118, where the format-preserving token 146 may include the structural characteristic based on the sensitive data 134. The method 300 may include a step 310 of providing the format-preserving token 146 to the tokenization API 106. The method 300 may include a step 312 of processing the encrypted data 188 and the format-preserving token 146 via the key management module 120 to generate the cryptographic key 148. The method 300 may include a step 314 of providing the cryptographic key 148 to the tokenization API 106. The method 300 may include a step 316 of applying the authorization rule for access control to the format-preserving token 146 and the cryptographic key 148 via the enforcement module 124 based on the user role 150 and the classification 152 of the sensitive data 134. The method 300 may include a step 318 of providing the format-preserving token 146 and the cryptographic key 148 to the distributed computing environment 140 via the tokenization API 106 based on the user role 150 and the classification 152 of the sensitive data 134.

As shown in FIG. 9, a method 400 for protecting sensitive data 134 with vaultless tokenization 138 across a distributed computing environment 140 is provided. The method 400 may include steps 302-308 of method 300 (as steps 402-408 respectively). The method 400 may include a step 410 of providing a data storage layer 132 that may be included in the memory 104. The method 400 may include a step 412 of storing the format-preserving token 146 in the data storage layer 132 separate from the sensitive data 134. The method 400 may include a step 414 of maintaining separation between the format-preserving token 146 and the sensitive data 134 to enhance security and compliance with data protection requirements. The method 400 may include steps 310-318 of method 300 (as steps 416-424 respectively).

As shown in FIG. 10, a method 500 for protecting sensitive data 134 with vaultless tokenization 138 across a distributed computing environment 140 is provided. The method 500 may include steps 302-304 of method 300 (as steps 502-504 respectively). The method 500 may include a step 506 of receiving the sensitive data 134 from a plurality of distributed computing environments 140 in a multi-tenant environment 164 via the tokenization API 106. The method 500 may include a step 508 of providing a tenant-specific token 166 to each distributed computing environment 140. The method 500 may include a step 510 of providing a tenant-specific cryptographic key 168 to each distributed computing environment 140. The method 500 may include a step 512 of facilitating tenant isolation through the provision of unique tokenization parameters for each tenant environment. The method 500 may include steps 306-318 of method 300 (as steps 514-526 respectively).

As shown in FIG. 11, a method 600 for protecting sensitive data 134 with vaultless tokenization 138 across a distributed computing environment 140 is provided. The method 600 may include steps 302-306 of method 300 (as steps 602-606 respectively). The method 600 may include a step 608 of executing an encryption algorithm 170 when applying the format-preserving cryptographic transformation 160 to the sensitive data 134, where the encryption algorithm 170 may include an advanced encryption standard (e.g., AES-256) 172, a secure hash algorithm (e.g., SHA-256) 174, or a format-preserving encryption 176. The method 600 may include a step 610 of accessing a hardware module 122 that may provide a tamper-resistant storage 200 for managing the cryptographic key 148. The method 600 may include a step 612 of implementing automated key rotation 198 through the hardware module 122 to maintain cryptographic security over time. The method 600 may include steps 308-318 of method 300 (as steps 614-624 respectively).

As shown in FIG. 12, a method 700 for protecting sensitive data 134 with vaultless tokenization 138 across a distributed computing environment 140 is provided. The method 700 may include steps 302-316 of method 300 (as steps 702-716 respectively). The method 700 may include a step 718 of applying a compliance policy 212 for a healthcare regulation 214 when enforcing the authorization rule. The method 700 may include a step 720 of generating an immutable audit trail 196 for the format-preserving token 146. The method 700 may include a step 722 of maintaining regulatory compliance through the systematic documentation of all tokenization activities and access events. The method 700 may include step 318 of method 300 (as step 724).

As shown in FIG. 13, a method 800 for protecting sensitive data 134 with vaultless tokenization 138 across a distributed computing environment 140 is provided. The method 800 may include steps 302-318 of method 300 (as steps 802-818 respectively). The method 800 may include a step 820 of providing a security module 126 in the memory 104 that may be operable to detect an anomalous activity 202 of a user of the distributed computing environment 140. The method 800 may include a step 822 of monitoring the encrypted data 188 and the format-preserving token 146 via the security module 126 to detect the anomalous activity 202. The method 800 may include a step 824 of transmitting the anomalous activity 202 to the enforcement module 124. The method 800 may include a step 826 of alerting the distributed computing environment 140 of a threat 204 based on the anomalous activity 202.

As shown in FIG. 14, a method 900 for protecting sensitive data 134 with vaultless tokenization 138 across a distributed computing environment 140 is provided. The method 600 may include steps 302-306 of method 300 (as steps 902-906 respectively). The method 900 may include a step 908 of providing a client portal 110 through which a user of the distributed computing environment 140 may grant the encryption module 116 access to a block of data 162 via the tokenization API 106. The method 900 may include a step 910 of accessing the block of data 162 via the tokenization API 106, where the access to the block of data 162 may be granted by the user of the distributed computing environment 140. The method 900 may include a step 912 of processing the block of data 162 that may include the sensitive data 134 or a non-sensitive data 134. The method 900 may include steps 308-318 of method 300 (as steps 914-924 respectively).

As shown in FIG. 15, a method 1000 for protecting sensitive data 134 with vaultless tokenization 138 across a distributed computing environment 140 is provided. The method 1000 may include steps 302-318 of method 300 (as steps 1002-1018 respectively). The method 1000 may include a step 1020 of providing an interoperability module 128 in the memory 104 that may be operable to generate a map 194 of a plurality of format-preserving tokens 146 across a plurality of distributed computing environments 140. The method 1000 may include a step 1022 of generating the map 194 of the plurality of format-preserving tokens 146, where the map 194 may include an electronic health record 206, a laboratory system 208, or an insurance platform 210. The method 1000 may include a step 1024 of facilitating cross-platform data sharing through the token map 194 functionality.

As shown in FIGS. 16A and 16B, a method 1100 of secure user interaction and protecting sensitive data 134 on a distributed computing environment 140 is provided. The method 1100 may include a step 1102 of providing the processor 102 and the memory 104, the memory 104 including the tokenization API 106 and the tokenization engine 118, the tokenization API 106 including a plugin 112. The method 1100 may include a step 1104 of receiving data from the user via the distributed computing environment 140 through the plugin 112. The method 1100 may also include a step 1106 of determining a class 154 that the user belongs to via the tokenization API 106. The method 1100 may include a step 1108 of determining a group 156 that the user belongs to via the tokenization API 106. The method 1100 may include a step 1110 of determining a posting location 158 that data will be posted to by the user via the tokenization API 106. The method 1100 may include a step 1112 of identifying a portion of the data provided by the user as sensitive data 134 via the tokenization engine 118. The method 1100 may include a step 1114 of generating a token via the tokenization engine 118, the token representing the sensitive data 134. The method 1100 may also include a step 1116 of replacing the portion determined as sensitive data 134 with the token via the tokenization engine 118. Finally, the method 1100 may include a step 1118 of communicating the data the sensitive data 134 or the token to the posting location 158 as determined by the class 154 and group 156 of the user via the plugin 112.

As shown in FIGS. 1-5, a non-transitory computer-readable storage medium 216 for storing processor instructions 218 for protecting sensitive data 134 with vaultless tokenization 138 across a distributed computing environment 140 is provided. The processor instructions 218 may cause the processor 102 to receive sensitive data 134 from the distributed computing environment 140 via a tokenization API 106 through the network 144. The processor instructions 218 may cause the processor 102 to apply a format-preserving cryptographic transformation 160 to the sensitive data 134 via an encryption module 116, creating encrypted data 188 while preserving the data format 190 and the length characteristic 192 of the sensitive data 134. The processor instructions 218 may cause the processor 102 to generate a format-preserving token 146 via a tokenization engine 118, where the format-preserving token 146 may include a structural characteristic based on the sensitive data 134. The processor instructions 218 may cause the processor 102 to provide the format-preserving token 146 to the tokenization API 106. The processor instructions 218 may cause the processor 102 to process the encrypted data 188 and the format-preserving token 146 via a cryptographic key 148 module to generate a cryptographic key 148. The processor instructions 218 may cause the processor 102 to provide the cryptographic key 148 to the tokenization API 106. The processor instructions 218 may cause the processor 102 to apply an authorization rule for access control to the format-preserving token 146 and the cryptographic key 148 via an enforcement module 124 based on a user role 150 and a classification 152 of the sensitive data 134. The processor instructions 218 may cause the processor 102 to provide the format-preserving token 146 and the cryptographic key 148 to the distributed computing environment 140 via the tokenization API 106 based on the user role 150 and the classification 152 of the sensitive data 134. The processor instructions 218 may cause the processor 102 to monitor the format-preserving token 146 and the cryptographic key 148 via a security module 126 to detect an anomalous activity 202. The processor instructions 218 may cause the processor 102 to store the format-preserving token 146 in a data storage layer 132 separated from the sensitive data 134.

The present technology may advantageously address challenges associated with conventional tokenization approaches that rely on centralized token storage systems and database-dependent architectures. The present technology may minimize performance bottlenecks that may occur with database lookup operations while providing enhanced scalability for distributed computing environments 140. The present technology may reduce security vulnerabilities that may arise from centralized token storage by employing cryptographic algorithms that generate tokens dynamically without requiring vault infrastructure. The present technology may provide improved compliance capabilities through format-preserving cryptographic transformation 160 that maintains data structure compatibility, while the stateless architecture may allow for seamless integration across the multi-tenant environment 164 without the operational overhead associated with managing token-to-data mappings in centralized repositories.

### EXAMPLES

Example embodiments of the present technology are provided with reference to the FIGS. 1-16B enclosed herewith.

### Example 1: Healthcare Provider Data Protection During Multi-System Integration

The healthcare organization may initiate tokenization processes when patient records containing sensitive data 134 may be transmitted between an EHR 206 and an insurance platform 210 through the distributed computing environment 140. The tokenization API 106 may receive personal health information including patient identifiers, medical record numbers, and treatment histories from multiple healthcare applications via the gateway 108. The system 100 may determine the class 154 of the requesting healthcare provider and evaluate the group 156 associations to establish appropriate access privileges for the sensitive data 134 processing. The processor 102 may coordinate with the memory 104 to ensure that all tokenization operations may be executed according to healthcare regulatory requirements.

The encryption module 116 may apply format-preserving cryptographic transformation 160 to the received sensitive data 134 as shown in FIG. 4, creating encrypted data 188 while maintaining the original data structure compatibility with legacy healthcare systems. The encryption algorithm 170 may utilize Advanced Encryption Standard (AES)-256 techniques combined with the format-preserving cryptographic transformation 160 so that the tokenized patient identifiers may retain structural characteristics for database compatibility. The tokenization engine 118 may process the encrypted data 188 through vaultless tokenization 138 algorithms that generate format-preserving tokens 146 without requiring centralized storage repositories. The generated tokens may maintain referential integrity across multiple healthcare platforms while preventing unauthorized access to the underlying sensitive data 134.

The key management module 120 may generate the cryptographic key 148 dynamically and coordinate with the hardware module 122 to ensure tamper-resistant storage 200 of cryptographic parameters, as shown in FIG. 4. The enforcement module 124 may apply authorization rules based on the determined class 154 of healthcare providers and the specific group 156 classifications associated with different types of medical specialties. The compliance module 130 may implement the Health Insurance Portability and Accountability Act (HIPAA), the General Data Protection Regulation Act (GDPR), and the Health Information Technology for Economic and Clinical Health Act (HITECH) requirements to ensure that all tokenization activities may be documented through an immutable audit trail 196. The security module 126 may monitor the tokenization processes to detect any anomalous activities 202 that may indicate unauthorized access attempts or system vulnerabilities.

The interoperability module 128 may generate a map 194 relationships between format-preserving tokens 146 across an EHR 206, a laboratory system 208, and an insurance platform 210 to allow for coordinated patient care activities. The tokenization API 106 may provide the format-preserving tokens 146 and associate the cryptographic key 148 to authorized healthcare systems based on the established user role 150 and data classification 152 parameters. The data storage layer 132 may maintain separation between tokenized data and the original sensitive data 134 to enhance security protections. The system 100 may allow for healthcare providers to perform population health analytics and clinical research using tokenized datasets while maintaining patient privacy protections throughout the data processing lifecycle.

The client portal 110 may allow healthcare administrators to configure tokenization policies and monitor system performance through web-based interfaces that provide real-time visibility into tokenization operations. The plugin 112 may integrate seamlessly with existing healthcare information systems to provide automatic tokenization of sensitive data 134 as data may be entered or transmitted through clinical workflows. The interface module 114 may implement secure authentication protocols, for example, JSON Web Token validation and Transport Layer Security certificate verification to ensure authorized access to tokenization services. The distributed computing environment 140 may benefit from enhanced scalability and reduced operational overhead through the vaultless tokenization architecture while maintaining compliance with healthcare data protection regulations.

### Example 2: Financial Services Multi-Tenant Payment Processing

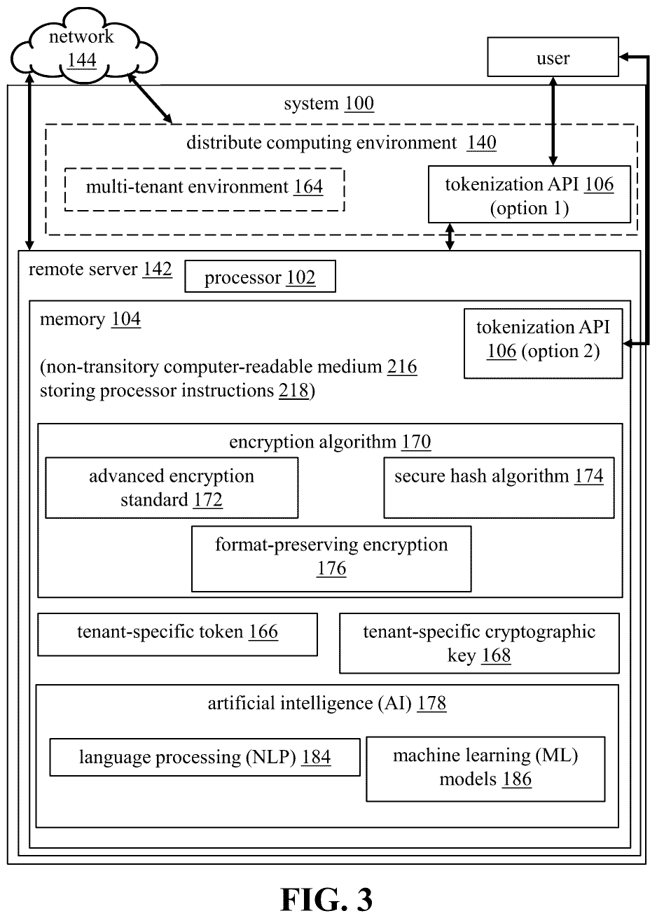

The financial services organization may deploy the tokenization system 100 across multiple distributed computing environments 140 to protect sensitive payment card information and personal identifiers during transaction processing activities. The tokenization API 106 may receive payment card numbers, account identifiers, and customer personal information from various point-of-sale systems and e-commerce platforms through the gateway 108. The system 100 may determine the class 154 of a merchant user and evaluate the group 156 associations of the user to establish appropriate tokenization policies for different types of financial transactions. The processor 102 may manage a multi-tenant environment 164, as shown in FIG. 3, where each financial institution may receive the tenant-specific token 166 and the tenant-specific cryptographic key 168 to ensure data isolation between different organizational entities.

The encryption module 116 may apply cryptographic transformations to sensitive payment data while preserving format characteristics that allow for compatibility with payment processing networks and regulatory compliance systems. The encryption algorithm 170 may implement both deterministic and probabilistic encryption methods to support different use cases including fraud detection analytics and payment settlement operations. The tokenization engine 118 may generate a format-preserving token 146 through vaultless tokenization 138 processes that eliminate dependencies on centralized token storage infrastructure while maintaining payment industry security standards. The tokens may preserve the structural properties of payment card numbers to ensure seamless integration with existing payment processing systems and merchant applications.

The key management module 120 may implement automated key rotation 198 procedures and coordinate with the hardware module 122 to provide tamper-resistant protection for cryptographic operations in accordance with payment card industry data security standard (PCI DSS) requirements. The enforcement module 124 may apply access control policies that vary based on the class 154 of the merchant and transaction group 156 categories to ensure appropriate authorization for tokenization and detokenization operations. The compliance module 130 may generate an audit trail 196 and regulatory reporting capabilities that demonstrate adherence to financial services regulations, e.g., the PCI DSS and regional data protection requirements. The security module 126 may monitor transaction patterns and tokenization activities to identify suspicious behaviors that may indicate fraudulent activities or security compromise attempts.

The interoperability module 128 may allow for the token map 194 across multiple payment processors, acquiring banks, and merchant service providers to facilitate coordinated fraud prevention and risk management activities. The tokenization API 106 may provide tokenized payment data and the cryptographic key 148 to authorized financial systems based on established merchant user roles 150 and transaction classification parameters. The data storage layer 132 may maintain strict separation between tokenized payment information and original sensitive data 134 to reduce the scope of Payment Card Industry compliance requirements. The system 100 may allow for financial institutions to perform transaction analytics and risk assessment using tokenized datasets while protecting cardholder information throughout payment processing workflows.

The client portal 110 may provide financial institution administrators with capabilities to configure tokenization policies, monitor transaction volumes, and generate compliance reports through secure web-based management interfaces. The plugin 112 may integrate with existing payment processing systems to provide real-time tokenization of sensitive payment data as transactions may be processed through merchant applications and payment gateways. The interface module 114 may implement strong authentication mechanisms including multi-factor authentication and certificate-based access controls to ensure secure access to tokenization services. The distributed computing environment 140 may achieve enhanced performance and scalability through the stateless vaultless tokenization architecture while maintaining the security protections required for financial services operations.

### Example 3: Community Forum Privacy Protection for Sensitive Discussions

The online community platform may implement the tokenization system 100 to protect personally identifiable information and sensitive user-generated content within healthcare discussion forums and support group environments. The tokenization API 106 may receive user posts, personal contact information, and health-related discussions from community forum applications through the gateway 108 as the user may participate in therapeutic and support conversations. The system 100 may determine the class 154 of forum users including patients, healthcare providers, and community moderators to establish appropriate tokenization policies for different types of sensitive information sharing. The processor 102 may coordinate tokenization operations across multiple forum topics and discussion groups where the user may belong to different group 156 classifications based on medical conditions or treatment categories.

The encryption module 116 may apply format-preserving cryptographic transformation 160 to sensitive user information including email addresses, phone numbers, and health condition details while maintaining the readability and utility of community discussions. The encryption algorithm 170 may implement selective tokenization techniques that protect PII while preserving the therapeutic value of shared experiences and support conversations. The tokenization engine 118 may process user-generated content through vaultless tokenization 138 algorithms that generate tokens for sensitive information without requiring centralized storage of personal details. The format-preserving tokens 146 may allow community members to engage in meaningful discussions while protecting the privacy of each member and preventing unauthorized access to personal health information.

The key management module 120 may generate the cryptographic key 148 for community forum tokenization operations and coordinate with the hardware module 122 to ensure secure management of encryption parameters across distributed forum environments. The enforcement module 124 may implement authorization policies that consider both the class 154 of forum users and the group 156 context of discussions to determine appropriate levels of tokenization for different types of sensitive information. The compliance module 130 may ensure adherence to privacy regulations including GDPR and other healthcare privacy requirements while maintaining an audit trail 196 of tokenization activities within community platforms. The security module 126 may monitor forum activities to detect potential privacy violations or unauthorized attempts to access tokenized user information.

The interoperability module 128 may allow for token consistency across multiple community platforms and healthcare support networks to allow the user to participate in discussions while maintaining privacy protections throughout different distributed computing environments 140. The tokenization API 106 may provide tokenized user content and appropriate cryptographic access to authorized community moderators and healthcare professionals based on established roles 150 and discussion group classifications. The data storage layer 132 may maintain separation between tokenized forum content and original user information to enhance privacy protections for community users. The system 100 may allow for community platforms to facilitate therapeutic discussions and peer support activities using tokenized data while protecting user anonymity and sensitive health information.

The client portal 110 may allow community administrators to configure tokenization policies for different discussion topics and manage user privacy settings through intuitive web-based interfaces. The plugin 112 may integrate with existing community forum software to provide automatic tokenization of sensitive user information as posts may be submitted and discussions may be conducted within therapeutic and support environments. The interface module 114 may implement user authentication and session management capabilities that ensure secure access to community features while protecting user identity information. The distributed computing environment 140 may benefit from enhanced user trust and regulatory compliance through the privacy-preserving tokenization capabilities while maintaining the collaborative and supportive nature of community healthcare discussions.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for protecting sensitive data with vaultless tokenization across a distributed computing environment, the system comprising:
a processor; and
a memory in communication with the processor, the memory including a tokenization application programming interface (API), an encryption module, a tokenization engine, a key management module, and an enforcement module,
wherein:
the tokenization API is configured to receive a sensitive data from the distributed computing environment through a network;
the encryption module is configured to receive the sensitive data and apply a format-preserving cryptographic transformation to the sensitive data, thereby creating an encrypted data, the encryption module preserving a data format and a length characteristic of the sensitive data;
the tokenization engine is configured to receive the encrypted data from the encryption module, generate a format-preserving token, the format-preserving token including a structural characteristic based on the sensitive data, and provide the format-preserving token to the tokenization API;
the key management module is configured to process the encrypted data and the format-preserving token, generate a cryptographic key, and provide the cryptographic key to the tokenization API; and
the enforcement module is configured to apply an authorization rule for access control to the format-preserving token and the cryptographic key based on a user role and a classification of the sensitive data;
wherein the tokenization API is configured to provide the format-preserving token and the cryptographic key to the distributed computing environment based on the user role and the classification of the sensitive data.

2. The system of claim 1, wherein the memory further includes a data storage layer that is configured to store the format-preserving token separate from the sensitive data.

3. The system of claim 1, wherein the tokenization API is configured to receive the sensitive data from a plurality of distributed computing environments in a multi-tenant environment, and the sensitive data provided by each distributed computing environment is provided a tenant-specific token and a tenant-specific cryptographic key.

4. The system of claim 1, wherein the encryption module is configured to execute an encryption algorithm, the encryption algorithm including a member selected from a group consisting of an advanced encryption standard, a secure hash algorithm, a format-preserving encryption, and combinations thereof.

5. The system of claim 1, wherein the key management module includes a hardware module that is configured to provide a tamper-resistant storage to manage the cryptographic key with an automated key rotation.

6. The system of claim 1, wherein the memory further includes a security module that is configured to detect an anomalous activity of a user of the distributed computing environment.

7. The system of claim 6, wherein the security module is configured to transmit the anomalous activity to the enforcement module and alert the distributed computing environment of a threat based on the anomalous activity.

8. The system of claim 1, further comprising a client portal configured to allow a user of the distributed computing environment to grant the encryption module access to a block of data via the tokenization API, the block of data including the sensitive data and non-sensitive data.

9. The system of claim 1, wherein the enforcement module is configured to apply a compliance policy for a healthcare regulation and generate an immutable audit trail for the format-preserving token.

10. The system of claim 1, wherein the memory further includes an interoperability module that is configured to generate a map of a plurality of format-preserving tokens across a plurality of distributed computing environments, the map including a member selected from a group consisting of an electronic health record, a laboratory system, an insurance platform, and combinations thereof.

11. A method for protecting sensitive data with vaultless tokenization across a distributed computing environment, comprising:
providing a processor, a memory in communication with the processor, the memory including a tokenization application programming interface (API), an encryption module, a tokenization engine, a key management module, and an enforcement module,
wherein:
the tokenization API is configured to receive a sensitive data from the distributed computing environment through a network,
the encryption module is configured to receive the sensitive data and apply a format-preserving cryptographic transformation to the sensitive data, thereby creating an encrypted data, the encryption module preserving a data format and a length characteristic of the sensitive data,
the tokenization engine is configured to receive the encrypted data from the encryption module, generate a format-preserving token, the format-preserving token including a structural characteristic based on the sensitive data, and provide the format-preserving token to the tokenization API,
the key management module is configured to process the encrypted data and the format-preserving token, generate a cryptographic key, and provide the cryptographic key to the tokenization API, and
the enforcement module is configured to apply an authorization rule for access control to the format-preserving token and the cryptographic key based on a user role and a classification of the sensitive data,
wherein the tokenization API is configured to provide the format-preserving token and the cryptographic key to the distributed computing environment based on the user role and the classification of the sensitive data;
receiving the sensitive data from the distributed computing environment via the tokenization API through the network;
applying the format-preserving cryptographic transformation to the sensitive data via the encryption module, thereby creating the encrypted data, the encryption module preserving the data format and the length characteristic of the sensitive data;
generating the format-preserving token via the tokenization engine, the format-preserving token including the structural characteristic based on the sensitive data;
providing the format-preserving token to the tokenization API;
processing the encrypted data and the format-preserving token via the key management module to generate the cryptographic key;
providing the cryptographic key to the tokenization API;
applying the authorization rule for access control to the format-preserving token and the cryptographic key via the enforcement module based on the user role and the classification of the sensitive data; and
providing the format-preserving token and the cryptographic key to the distributed computing environment via the tokenization API based on the user role and the classification of the sensitive data.

12. The method of claim 11, wherein:
the memory further includes a data storage layer configured to store the format-preserving token separate from the sensitive data; and
the method further comprises storing the format-preserving token in the data storage layer separate from the sensitive data.

13. The method of claim 11, wherein:
the tokenization API is configured to receive the sensitive data from a plurality of distributed computing environments in a multi-tenant environment, and provides a tenant-specific token and a tenant-specific cryptographic key to each distributed computing environment; and
the method further comprises providing the tenant-specific token and the tenant-specific cryptographic key to each distributed computing environment.

14. The method of claim 11, wherein applying the format-preserving cryptographic transformation to the sensitive data further includes executing an encryption algorithm, the encryption algorithm including a member selected from a group consisting of an advanced encryption standard, a secure hash algorithm, a format-preserving encryption, and combinations thereof.

15. The method of claim 11, wherein obtaining the cryptographic key further includes accessing a hardware module that provides a tamper-resistant storage for managing the cryptographic key with an automated key rotation.

16. The method of claim 11, wherein enforcing the authorization rule includes applying a compliance policy for a healthcare regulation and generating an immutable audit trail for the format-preserving token.

17. The method of claim 11, wherein:
the memory further includes a security module that is configured to detect an anomalous activity of a use of the distributed computing environment; and
the method further comprises:
monitoring, via the security module, the encrypted data and the format-preserving token to detect the anomalous activity;
transmitting the anomalous activity to the enforcement module; and
alerting the distributed computing environment of a threat based on the anomalous activity.

18. The method of claim 11, further comprising:
a client portal wherein a user of the distributed computing environment grants the encryption module access to a block of data via the tokenization API, the block of data including a member selected from a group consisting of the sensitive data, a non-sensitive data, and combinations thereof; and
the method further comprises accessing the block of data via the tokenization API, wherein the access to the block of data is granted by the user of the distributed computing environment.

19. The method of claim 11, wherein:
the memory further includes an interoperability module that is configured to generate a map of a plurality of format-preserving tokens across a plurality of distributed computing environments, the map including a member selected from a group consisting of an electronic health record, a laboratory system, an insurance platform, and combinations thereof; and
the method further comprises generating the map of the plurality of format-preserving tokens.

20. A non-transitory computer-readable storage medium, operable to store processor instructions for protecting sensitive data with vaultless tokenization across a distributed computing environment that, when the processor instructions are executed by a processor, causes the processor to:
receive a sensitive data from the distributed computing environment via a application programming interface (API) through a network;
apply a format-preserving cryptographic transformation to the sensitive data via an encryption module, thereby creating an encrypted data, the encryption module preserving a data format and a length characteristic of the sensitive data;
generate a format-preserving token via a tokenization engine, the format-preserving token including a structural characteristic based on the sensitive data;
provide the format-preserving token to the tokenization API;
process the encrypted data and the format-preserving token via a cryptographic key module to generate a cryptographic key;
provide the cryptographic key to the tokenization API;
apply an authorization rule for access control to the format-preserving token and the cryptographic key via an enforcement module based on a user role and a classification of the sensitive data;
providing the format-preserving token and the cryptographic key to the distributed computing environment via the tokenization API based on the user role and the classification of the sensitive data;
monitor the format-preserving token and the cryptographic key via a security module to detect an anomalous activity; and
store the format-preserving token in a data storage layer separated from the sensitive data.
